(19) United States
(12) Patent Application Publication
(10) Pub. No.: US 2024/0246262 A1
(43) Pub. Date: Jul. 25, 2024

(54) APPARATUS FOR RECYCLING POLYMERIC MATERIALS AND METHODS THEREOF

(71) Applicant: Revital ELBAZ SROR, Achisamach (IL)

(72) Inventor: Revital ELBAZ SROR, Achisamach (IL)

(21) Appl. No.: 18/289,894

(22) PCT Filed: May 11, 2022
(86) PCT No.: PCT/IB2022/054389

§ 371 Date: Nov. 8, 2023

Related U.S. Application Data
(60) Provisional application No. 63/186,834, filed on May 11, 2021.

(51) Int. Cl. B29B 17/00; B29L 31/00; G07F 7/06

(52) U.S. Cl. CPC B29B 17/0042; G07F 7/06; B29L 2031/7158

(57) ABSTRACT

An apparatus recycles recyclable materials and has an input that receives a quantity of the recyclable materials. A modification unit of the apparatus receives the quantity of the recyclable material from the input, and selectively produces a modified material from at least some of the quantity of the recyclable material. An output of the apparatus provides the modified material as output. In certain preferred embodiments, a user interface is provided for selecting how the quantity of the recyclable materials is to be modified by the modification unit.

### CROSS-REFERENCE TO RELATED APPLICATIONS

This application claims priority from U.S. Provisional Patent Application No. 63/186,834, filed on May 11, 2021, the disclosure of which is incorporated by reference in its entirety herein.

### TECHNICAL FIELD OF THE INVENTION

The present invention relates to a new recycling apparatus and method thereof, particularly to an apparatus and method thereof for recycling plastic bottles and instantly generating new recycled products from said apparatus and method.

### BACKGROUND OF THE INVENTION

Nowadays, earth pollution is a major and important issue, and awareness and importance are rising year by year. Recycling plastic products is one of the issues that greatly affects the issue of air, land and sea pollution, which cause great damage all over the world.

Many people all over the world, every day use plastic bottles (including other plastic products) which are intended for single use. This consumption causes millions of bottles to contaminate beaches, parks, roads and many other places, all over the world.

Although there are various conventional solutions which provide cycles and/or different ways of recycling. However, these solutions cause air pollution and a lot of polluting operation, which is still environmental unacceptable. In addition, conventional recycling machines and methods are expensive, time-consuming, complicated including many steps and the machines are not user friendly, depending on the expertise of workers in this field.

### SUMMARY OF THE INVENTION

The invention is related to a new recycling apparatus and method thereof, avoiding the disadvantages associated with previous recycling machines and methods, namely to provide an immediate, fast, low-cost, practical and environmentally friendly solution. Said apparatus and method are original, innovative, creative, practical, and commercial solution for people of all ages who are interested in recycling polymeric materials, such as plastic bottles in public places and/or in general.

According to the teachings of an embodiment of the present invention, there is provided an apparatus for recycling recyclable materials. The present invention further provides a method of recycling recyclable materials, using the recycling apparatus defined herein.

According to preferred embodiments, the apparatus comprises a) an input for receiving a quantity of the recyclable materials; b) a modification unit for receiving the quantity of the recyclable material from the input and selectively producing a modified material from at least some of the quantity of the recyclable material; and c) an output for providing the modified material.

According to further preferred embodiments, the apparatus further comprises a user interface for selecting how the quantity of the recyclable materials is to be modified by the modification unit. According to still further embodiments, said user interface is a digital screen and/or application with a menu, wherein the user interface is configured to receive instructions from a costumer/consumer or from a manufacturer.

According to still further embodiments, said apparatus comprises a controller having at least one processor associated with the user interface for actuating the modification unit to modify the quantity of the recyclable materials in response to input received from the user interface.

According to preferred embodiments, the recyclable materials are selected from the group consisting of: papers, glasses, wood, metal, and polymeric materials. According to still preferred embodiments, the recyclable material is a polymeric material. According to still preferred embodiments, the polymeric material is a plastic material. According to still preferred embodiments, the plastic material is selected from the group consisting of: plastic bottles, and boxes.

According to preferred embodiments, modified material is a new recycled product or a recycled material.

According to preferred embodiments, a costumer/consumer can choose from the menu to receive a new recycled product and to receive a payment for inserting the recyclable material. According to further preferred embodiments, the new recycled product is selected from the group consisting of: slippers, ball game sticks, toys, tools, a ruler, and a stand.

According to preferred embodiments, a manufacturer can retrieve the recycled material from said apparatus.

According to preferred embodiments, the method of recycling recyclable materials, which uses the apparatus defined herein, comprises: an input for receiving a quantity of the recyclable materials, a modification unit for receiving the quantity of the recyclable material from the input and selectively producing a modified material from at least some of the quantity of the recyclable material, a user interface for selecting how the quantity of the recyclable materials is to be modified by the modification unit, and an output for providing the modified material, the method comprising: a) inserting the recyclable material into the input of the apparatus; b) selecting, via the user interface, the desired new recycled product or recycling the material receiving payment; wherein the apparatus starts recycling by operating the modification unit which includes: c) a grinding/crushing unit: d) a melting/heating unit; e) a pressing, soldering and molding unit; and f) a finishing unit.

According to further preferred embodiments, said method is executed all inside said apparatus. According to still preferred embodiments, said method is performed in at most 2 minutes.

According to preferred embodiments, if the costumer/consumer chooses to have a new recycled product, said new recycled product comes out from the output of the apparatus.

According to preferred embodiments, if the manufacturer chooses to collect the recycled product, said recycled product comes out from the output of the apparatus.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 illustrates an example of recyclable materials that can be input into an apparatus according to embodiments of the present invention;

FIG. 2 is a schematic representation of an apparatus for receiving a quantity of recyclable materials and producing therefrom a modified material, according to embodiments of the present invention;

FIG. 3 is a schematic representation of a modification unit, and subcomponents thereof, of the apparatus of FIG. 2, according to embodiments of the present invention:

FIGS. 4A-C schematically illustrate different views of the apparatus of FIG. 2, according to embodiments of the present invention;

FIG. 5 schematically illustrates a user interface of the apparatus, showing options of a new recycled product that can be selected, according to embodiments of the present invention; and

FIG. 6 illustrates a block diagram of an apparatus according to embodiments of the present invention, showing a user interface, a modification unit, and a controller associated/linked to the user interface and the modification unit.

### DESCRIPTION OF THE PREFERRED EMBODIMENTS

The present invention is related to a non-polluting recycling apparatus and method thereof. Said apparatus and method provide an immediate new recycled product thereof and dispenses both the industrial space and the need for recycling expertise. The present invention relates to a new recycling apparatus and method thereof, particularly to a method for recycling plastic bottles and generating new recycled products from said method. The method is executed in one single, stand-alone, small, compact and simple apparatus, which turn plastic bottles—or any other recyclable materials—into new, attractive and recycled products. The apparatus can be placed in many locations, is user friendly, and it is made accessible to many populations.

Certain embodiments of the present invention provide an apparatus that includes an input that receive a quantity of recyclable materials, a modification unit that modifies the quantity of recyclable materials to produce a modified material, and an output that provides the modified material

The principles and operation of the recycling apparatus and method according to present invention may be better understood with reference to the drawings accompanying the description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

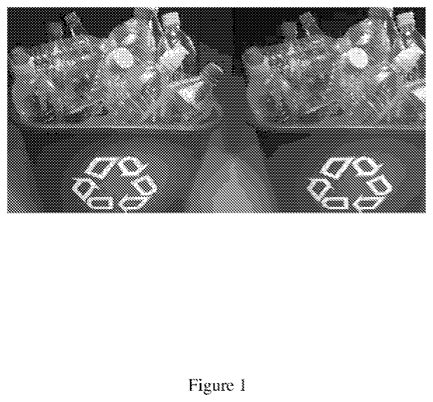

Referring now to the drawings, FIG. 1 illustrates recyclable plastic bottles in recycling material boxes. This represents the issue of recyclable plastic materials, which usually are before accumulated in boxes, then sent to factories or other specialized places that recycle; so the known recycling process is done in different time/spaces, being very time-consuming and non-environmental friendly.

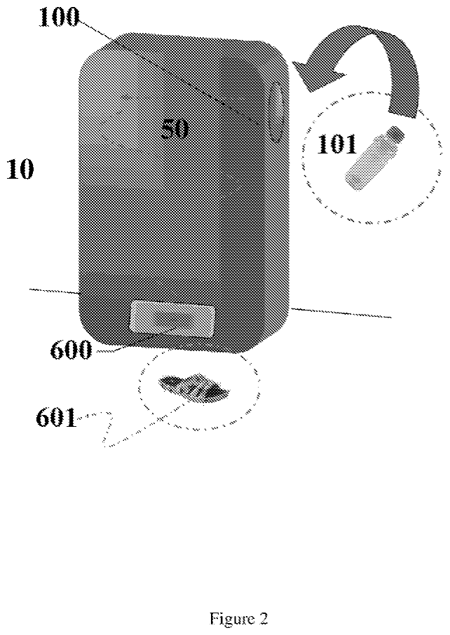

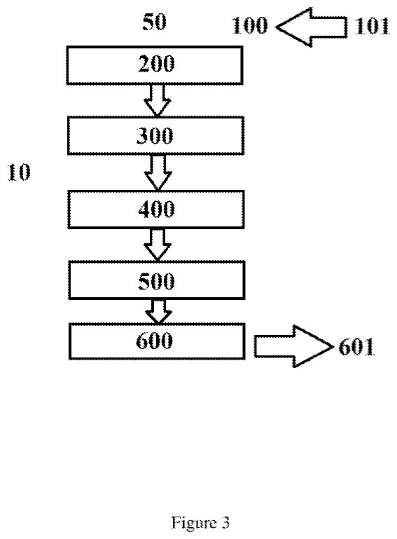

FIG. 2 illustrates an apparatus, generally designated 10, for recycling recyclable materials and creating a new recycled product (a “modified material”) according to certain non-limiting embodiments of the present invention. Generally speaking, the apparatus 10 has an input 100 (also referred to herein as an “entry point” of the apparatus 10), for receiving a quantity of recyclable materials 101 from a costumer/consumer. In FIG. 2, the quantity of recyclable materials 101 is represented as a plastic bottle—but other recyclable materials are also applicable—that is to be inserted into the apparatus 10. The apparatus 10 further includes a modification unit 50 that receives the quantity of recyclable materials 101 via the input 100 and processes the quantity of recyclable materials 101 by modifying the quantity of recyclable materials 101 to produce a modified material (a new recycled product). The modification unit 50 is formed from multiple sub-units, which will be described with reference to FIG. 3. The apparatus 10 also includes an output “600” (also referred to herein as a “departure point”) from where the new recycled product 601, represented for instance as a slipper in FIG. 2, is provided as output from the apparatus 10. In preferred embodiments, the modification unit 50 is retained within a housing 60 of the apparatus 10, and the input 100 and output 600 are each openings in the housing 60. The input 100 is preferably connected to an input of the first sub-unit (designated 200 in FIG. 3) of the modification unit 50 via a conduit or other connection arrangement; and the output 600 is preferably connected to an output of the last sub-unit (designated 500 in FIG. 3) of the modification unit 50 via a conduit or other connection arrangement.

FIG. 3 illustrates the sub-components of the modification unit 50 used for generating a new recycled product, such slippers for sea (601), from the recyclable materials 101. In the non-limiting embodiment illustrated in FIG. 3, the modification unit 50 includes a grinding/crushing unit 200, a melting/heating unit 300, a pressing (or pickling)/soldering/molding unit 400, and a finishing unit 500. Each of these sub-units of the modification unit 50 can be implemented in various ways and performs different functions. After the costumer/consumer inserting the recyclable material 101—for instance, the plastic bottle—into the apparatus input (100), the grinding/crushing unit 200 grinds and/or crushes the quantity of recyclable materials 101. The grinding/crushing unit 200 grinds and/or crushes received quantities of recyclable materials using any suitable grinding/crushing/shredding mechanisms, including, but not limited to, one or more blades, and one or more rollers with blades. The crushed material is then provided to the melting/heating unit 300, which functions to melt and/or heat the crushed quantity of recyclable materials 101 using any suitable heating mechanism, including, but not limited to, an arrangement of heat sources such as incandescent bulbs or LEDs. The heated/melted material is then provided to the pressing/soldering/molding unit 400, which performs a three-step sub-process to form the desired modified material, whereby the heated recyclable materials are pressed, soldered and then molded. The molding can be performed using any suitable technique, including, but not limited to, casting and injection molding. In fact, the apparatus can store within the housing 60 a plurality of molds that form the shape of the selected modified material (new product). The molded material is then provided to the finishing unit 500, which performs a finishing process to the new recycled product 601, for example, polishing, painting, cleaning, and the like. The finishing unit 500 then provides the finished product to the output 600.

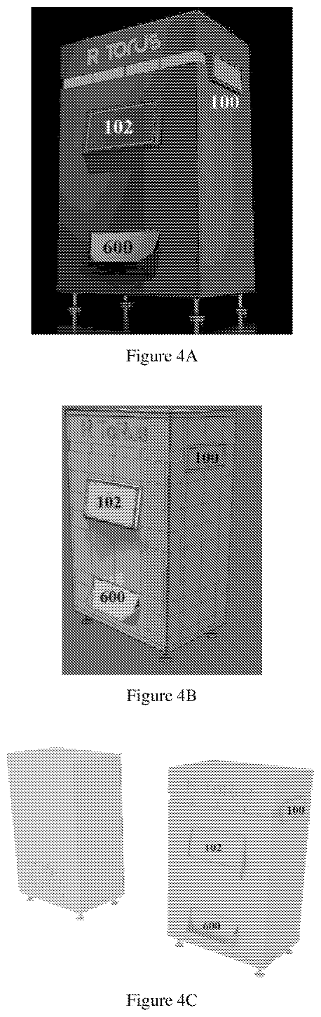

FIGS. 4A-C illustrate different views from the recycling apparatus. FIG. 4A shows the apparatus in a 3D representation, with the input 100, a user interface 102, implemented for example as a digital screen and/or application with a menu, and the output 600. FIG. 4B shows the same apparatus in a schematic representation, also with the input 100, the user interface 102, and the output 600; lastly, FIG. 4C shows the apparatus with the input 100, the user interface 102, and the output 600, and the back of the apparatus.

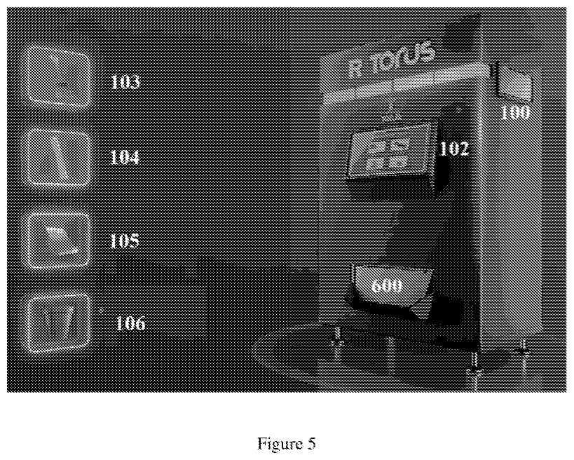

FIG. 5 illustrate the user interface 102 implemented as a digital screen and/or application with menu options of new recycled product to select. The user interface 102 is used by the costumer/consumer or the manufacturer; the costumer/consumer selects one of the options in the menu of the user interface according to which new recycled product said costumer/consumer desires, and/or selects to receive payment for inserting a recyclable material. Some non-limiting exemplary menu options of new recycled product that can be displayed in the menu of the user interface 102 are: beach toys 103, ruler for school 104, and stand for smartphone 105, or other inexpensive product 106. The manufacturer can retrieve the recycled material from the apparatus.

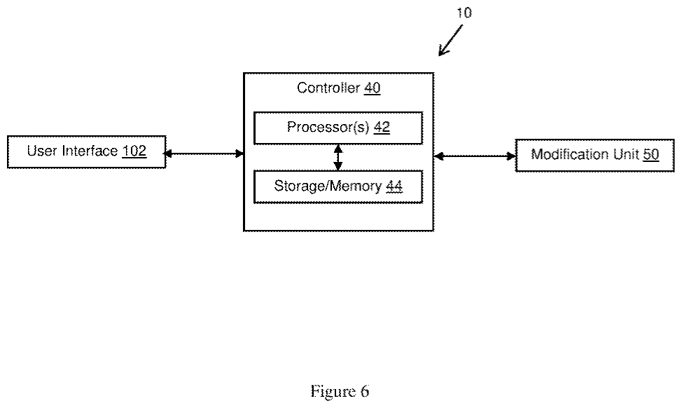

With reference to FIG. 6, which illustrates a block diagram of the apparatus 10, in certain embodiments the apparatus 10 further includes a controller 40 functionally (e.g., electrically) associated with the user interface 102 and the modification unit 50 for actuating the modification unit 50 to modify the quantity of the recyclable materials in response to input (e.g., customer/consumer input) received from the user interface 102. The controller 40 is preferably a computerized controller having one or more processors 42 coupled to a computerized storage medium 44, such as a computerized memory or the like. The one or more processors 42 can be implemented as any number of computerized processors, including, but not limited to, microprocessors, microcontrollers, application-specific integrated circuits (ASICs), field programmable gate arrays (FPGAs), digital signal processors (DSPs), field-programmable logic arrays (FPLAs), and the like. In microprocessor implementations, the microprocessors can be, for example, conventional processors, such as those used in servers, computers, and other computerized devices. For example, the microprocessors may include x86 Processors from AMD and Intel, Xeon® and Pentium® processors from Intel, as well as any combinations thereof. The aforementioned computerized processors include, or may be in electronic communication with computer readable media, which stores program code or instruction sets that, when executed by the computerized processor, cause the computerized processor to perform actions. Types of computer readable media include, but are not limited to, electronic, optical, magnetic, or other storage or transmission devices capable of providing a computerized processor with computer readable instructions.
The storage/memory 44 can be any conventional or application specific storage media, which although shown as a single component for representative purposes, may be multiple components. The storage/memory 44 can be implemented in various ways, including, for example, one or more volatile or non-volatile memory, a flash memory, a read-only memory, a random-access memory, and the like, or any combination thereof. In certain embodiments, the storage/memory 44 can include one or more components configured to store machine executable instructions that can be executed by the one or more processors 42.

The controller 40 is preferably configured to execute program code that can detect discrepancies between the amount of material present in the apparatus, and the customer/consumer's request. The apparatus can contain in the housing 60 excess material from previous operations and/or from those costumers/consumers that requested payment instead of a new product. In certain embodiments, the apparatus 10 can include a sensor that measures the mass of the material inserted into the apparatus (e.g., the costumer/consumer inserts a 500 mL bottle and the sensor measures a mass of 200 g). Then, based on the mass measurement and the item selection in the user interface, the controller 40 can compare the mass/amount of recyclable material that is required to produce the selected item. If there is insufficient material, the user interface can output a message indicating as such (the selected item requires X amount of material and you only inserted Y), and suggest an alternative item for which there is sufficient material. For example, if the costumer/consumer inserts 200 g of plastic and selects slippers as the new product, but slippers require 300 g of plastic, the user interface can output a message saying that the selected item (e.g., slippers) requires a certain amount of material and that the inserted quantity of material is insufficient to produce the selected item, and maybe suggest play tools instead (which require 200 g of material). The interface can also filter the list of selectable items based on the amount of recyclable material inserted into the apparatus. For example, if the user inserts 200 g of plastic, slippers (which require 300 g of plastic) would not be a selectable option in the user interface, but play tools (200 g) and ball game sticks (150 g) would be selectable. In certain scenarios, if the recyclable material is more than enough to produce the selected item such that there is material leftover after the new recycled product is produced, the recycled material can be collected by a recycling material collection company, and the owner/operator of the apparatus can receive payment for the collected recyclable materials. Thus, a modified material (i.e., new recycled product) can be produced partly from the material that a current user inserts into the apparatus 10 and partly from excess material stored in the apparatus. Therefore, in general, the following three scenarios hold for producing a modified material: a) all of the quantity of the recyclable material inserted into the apparatus by the current customer/user is used to make the new recycled product and no stored material is used; b) all the quantity of the material inserted into the apparatus by the current customer/user is used to make the new product and some stored material is used; or c) some of the quantity of the material inserted into the apparatus by the current customer/user is used and some stored material is used.

The apparatus according to the embodiments disclosed herein is simple to operate: insert the bottle—or any other recyclable material—into the input, and after approximately 2 minutes, a new and attractive recycled product will come out of the apparatus's output. The costumer/consumer needs only to select the desired product from the user interface implemented as a digital screen and/or application with menu options. The apparatus disclosed herein is compact and practical, and recycles bottles and/or other recyclable materials quickly in an environmentally friendly fashion. Preferably, the apparatus can be deployed in public places where there is a large consumption of bottles. Some non-limiting examples of deployment locations for the apparatus include: shopping centers, shopping malls, street markets, and sports facilities (e.g., soccer fields, etc.).

In operation, a customer/consumer that has finished using a bottle can insert the empty bottle(s) into the apparatus. The customer/consumer has options in the user interface for selecting one of the following: a) choosing to have the apparatus work immediately, and the same apparatus will crush bottles and plastic products, and creating a product that the customer/consumer can immediately use for purposes and/or completely different uses from a “drinking bottle” (all in one apparatus); b) choosing to receive a payment (for example a few cents for every 10 grams of shredded/recycled material), instead of a ready-made product that left the apparatus after a few minutes (2 minutes); or c) selecting that a recycling manager (associated with the apparatus) receive a SMS (or any other kind of message), indicating that the apparatus is full of recycled material and someone can directly take the material from the apparatus for collection.

As discussed above, various new recycled products can be produced from recyclable materials using the apparatus disclosed herein. Some non-limiting examples of new recycled products include: slippers for the sea and/or in general, ball game sticks, and playing tools for sand in the sea/yard. A wide variety of different molds can be incorporated into the sub-unit 400 in order to facilitate production of the different new recycled products. As discussed above, some of the steps executed in order to produce a new product include: inserting the recyclable material into the input of the apparatus, and selecting, from the menu on the user interface (e.g., digital screen and/or app), the desired new recycled product or recycling the material and receiving payment. If a new recycled product is selected, the apparatus creates the new product by employing the following sub-units: grinding/crushing unit, melting/heating unit, pressing/soldering/molding unit (which execute a three-step sub-process), and the finishing unit.

In certain embodiments, one or more of the above steps can be changed according to different purposes of apparatus working. For instance, additional technical steps can be further combined in the step executed by the pressing/soldering/molding unit, including one or more of: casting/injection molding, pickling/pressing, punching/cutting with a knife, and 3D printing.

In certain embodiments, the user interface can provide an advertising platform for other business, which enable the operator/owner of the apparatus to profit from advertising.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form. “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

“Recyclable material” herein is defined as many kinds of glass, paper, wood, cardboard, metal, polymer, tires, textiles, batteries, and electronics that can be collected and recyclable. Preferably, the recyclable material can be papers, glasses, wood, metal or polymeric materials. The recyclable material is preferably a polymeric material.

“Polymeric material” herein is defined as materials made of long, repeating chains of molecules, such as plastic materials.

“Plastic material” herein is defined as plastic bottles, boxes, or any other plastic recyclable material.

“New recycled product” herein is defined as any recycled product that comes from a recyclable material, which passed through recycling process. Preferably, the new recycled products can be slippers for the sea and/or in general, ball game sticks, toys, playing tools (for instance, tools for sand in the sea/yard, a ruler, a stand (for instance, a stand for smartphone), and related products. A large and wide variety of different molds can be incorporated into this ready-made and manufacturing process so many different related new recycled products can be made.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An apparatus for recycling recyclable materials, comprising:
a) an input for receiving a quantity of the recyclable materials;
b) a modification unit for receiving the quantity of the recyclable material from the input and selectively producing a modified material from at least some of the quantity of the recyclable material; and
c) an output for providing the modified material.

2. The apparatus of claim 1, further comprising: a user interface for selecting how the quantity of the recyclable materials is to be modified by the modification unit.

3. The apparatus according to claim 2, wherein the user interface is a digital screen and/or application with a menu, wherein the user interface is configured to receive instructions from a costumer/consumer or from a manufacturer.

4. The apparatus according to claim 2, further comprising: a controller having at least one processor associated with the user interface for actuating the modification unit to modify the quantity of the recyclable materials in response to input received from the user interface.

5. The apparatus according to claim 1, wherein the recyclable materials are selected from the group consisting of: papers, glasses, wood, metal, and polymeric materials.

6. The apparatus according to claim 1, wherein the recyclable material is a polymeric material.

7. The apparatus according to claim 6, wherein the polymeric material is a plastic material.

8. The apparatus according to claim 7, wherein the plastic material is selected from the group consisting of: plastic bottles, and boxes.

9. The apparatus according to claim 1, wherein modified material is a new recycled product or a recycled material.

10. The apparatus according to claim 3, wherein a costumer/consumer can choose from the menu to receive a new recycled product and to receive a payment for inserting the recyclable material.

11. The apparatus according to claim 10, wherein the new recycled product is selected from the group consisting of: slippers, ball game sticks, toys, tools, a ruler, and a stand.

12. The apparatus according to claim 1, wherein a manufacturer can retrieve the recycled material from said apparatus.

13. A method of recycling recyclable materials, using an apparatus that comprises: an input for receiving a quantity of the recyclable materials, a modification unit for receiving the quantity of the recyclable material from the input and selectively producing a modified material from at least some of the quantity of the recyclable material, a user interface for selecting how the quantity of the recyclable materials is to be modified by the modification unit, and an output for providing the modified material, the method comprising:
a) inserting the recyclable material into the input of the apparatus;
b) selecting, via the user interface, the desired new recycled product or recycling the material receiving payment:
wherein the apparatus starts recycling by operating the modification unit which includes:
c) a grinding/crushing unit;
d) a melting/heating unit;
e) a pressing, soldering and molding unit; and
f) a finishing unit.

14. The method according to claim 13, wherein said method is executed all inside said apparatus.

15. The method according to claim 14, wherein said method is performed in at most 2 minutes.

16. The method according to claim 13, wherein if the costumer/consumer chooses to have a new recycled product, said new recycled product comes out from the output of the apparatus.

17. The method according to claim 13, wherein if the manufacturer chooses to collect the recycled product, said recycled product comes out from the output of the apparatus.
